(19) United States
(12) Patent Application Publication
(10) Pub. No.: US 2014/0344509 A1
(43) Pub. Date: Nov. 20, 2014

(54) HARD DISK CACHING WITH AUTOMATED DISCOVERY OF CACHEABLE FILES

(71) Applicants: Louis A. Duran, Hillsboro, OR (US); Brian L. Vajda, Portland, OR (US); Punit Modi, El Dorado Hills, CA (US)

(72) Inventors: Louis A. Duran, Hillsboro, OR (US); Brian L. Vajda, Portland, OR (US); Punit Modi, El Dorado Hills, CA (US)

(21) Appl. No.: 14/285,382

(22) Filed: May 22, 2014

Related U.S. Application Data
(63) Continuation of application No. 11/646,643, filed on Dec. 27, 2006.

(51) Int. Cl. G06F 12/08; G06F 12/02

(52) U.S. Cl. CPC G06F 12/0866; G06F 12/0246; G06F 12/0891; G06F 2212/222; G06F 2212/28; G06F 2212/7205
USPC 711/103

(57) ABSTRACT

In some embodiments a permanent cache list of files not to be removed from a cache is determined in response to a user selection of an application to be added to the cache. The determination is made by adding a file to the cache list if the file is a static dependency of the application, or if a file has a high probability of being used in the future by the application. Other embodiments are described and claimed.

### CROSS-REFERENCE TO RELATED APPLICATIONS

This application is a continuation of prior co-pending U.S. patent application Ser. No. 11/646,643 filed Dec. 27, 2006. This prior U.S. Patent Application is hereby incorporated herein by reference in its entirety.

### TECHNICAL FIELD

Embodiments of the invention generally relate to hard disk caching with automated discovery of cacheable files.

### BACKGROUND

A hard disk drive often has an associated disk cache that is used to speed up access to data on the disk since the access speed of the disk cache is significantly faster than the access speed of the hard disk drive. A disk cache is a storage device that is often a non-volatile storage device such as a Random Access Memory (RAM) or a flash memory. The disk cache can be part of the disk drive itself (sometimes referred to as a hard disk cache or buffer) or can be a memory or portion of a memory (for example, a portion of a general purpose RAM that is reserved for use by the disk drive) in a computer (sometimes referred to as a soft disk cache). Most modern disk drives include at least a small amount of internal cache.

A disk cache often includes a relatively large amount of non-volatile memory (for example, flash memory) and/or software drivers to control the operation of the cache. It is typically implemented by storing the most recently accessed data. When a computer needs to access new data the disk cache is first checked before attempting to read the data from the disk drive. Since data access from the cache is significantly faster than data access from the disk drive, disk caching can significantly increase performance. Some cache devices also attempt to predict what data might be requested next so that the data can be place on the cache in advance. Currently, software drivers that perform disk caching use a simple least recently used (LRU) algorithm to determine what data needs to be removed from the cache so that new data can be added. This is referred to as “cache eviction”. However, in some circumstances a user may wish to have a permanent cacheable list so that some files are never evicted from the disk cache.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a flow according to some embodiments of the inventions.

### DETAILED DESCRIPTION

Some embodiments relate to hard disk caching with automated discovery of cacheable files.

Some embodiments relate to hard disk caching with automated discovery of permanently cacheable files.

Some embodiments have been described herein as relating to permanently cacheable files or cacheable files and/or permanent cache lists or cache lists, for example. It is noted that these terms are generally used with or without the term “permanent” to mean roughly the same concept. That is, permanent as used herein is permanent in the sense, for example, that disk addresses representing an application will be in the cache until the user decides to purge them from the cache with some other data, for example (as opposed to being evicted from the cache based on some preprogrammed policy such as a least recently used algorithm). Additionally, other terms such as “pinned data” vs. “unpinned data”, etc. are used herein to discuss data in cache lists, cache files, permanent cache lists, permanent cache files, etc.

In some embodiments a cache list of files not to be removed from a cache is determined in response to a user selection of an application to be added to the cache. For example, the cache list of files is not to be removed from the cache until the user decides to remove the file or group of files (as opposed to being evicted from the cache based on some pre-programmed policy such as a least recently used algorithm, for example). The determination is made by adding a file to the permanent cache list if the file is a static dependency of the application.

In some embodiments a permanent cache list of files not to be removed from a cache is determined in response to a user selection of an application to be added to the cache. The determination is made by adding a file to the cache list if the file is a static dependency of the application, and/or if a file has a high probability of being used in the future by the application.

In some embodiments an apparatus includes a cache and cache logic. The cache logic is to determine, in response to a user selection of an application to be added to a cache, a permanent cache list of files not to be removed from the cache by adding a file to the permanent cache list if the file is a static dependency of the application.

In some embodiments a system includes one or more disk drives, a cache to cache information held on the disk drive, and cache logic. The cache logic is to determine, in response to a user selection of an application to be added to the cache, a permanent cache list of files not to be removed from the cache by adding a file to the permanent cache list if the file is a static dependency of the application.

In some embodiments an article includes a computer readable medium having instructions thereon which when executed cause a computer to determine, in response to a user selection of an application to be added to a cache, a permanent cache list of files not to be removed from the cache by adding a file to the permanent cache list if the file is a static dependency of the application.

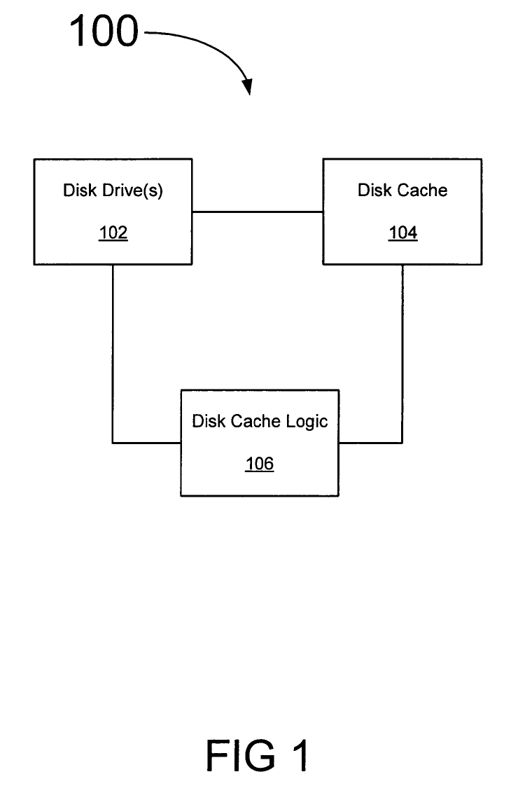

FIG. 1 illustrates a system 100 according to some embodiments. In some embodiments system 100 includes one or more disk drives 102, one or more disk cache 104, and disk cache logic 106. Disk cache logic 106 may be implemented, for example, in software, hardware, and/or firmware, including any combination thereof. In some embodiments disk cache 104 includes a relatively large amount of non-volatile memory (for example, flash memory) and/or software drivers to control operation of the cache. In some embodiments disk cache logic 106 includes non-volatile memory and/or software drivers to control operation of the cache.

In some embodiments, software drivers within disk cache 104 and/or disk cache logic 106 may use, for example, a simple LRU (least recently used) algorithm to determine cache eviction and/or may use other algorithms to determine cache eviction. In some embodiments disk cache logic 106 enables intelligent disk caching of files that would normally be loaded from disk drive(s) 102 when used. For example, in some embodiments a user is allowed to pick applications that should always be cached (for example, stored as part of a permanent cache list). Disk data associated with files that a user has picked to always be cached are identified as being files that should never be evicted from the cache 104. Based on a minimal amount of user input of a user selecting an application to be added to the cache, the application and all of its dependent files are heuristically determined. For example, based on dynamically linked and statically linked dependencies and a runtime analysis of filed used, a list of additional files is determined to be associated with the selected application, and the files can be loaded into the cache 104 from anywhere on the disk 102 (or disks).

In some embodiments, once a user selects an application to cache, a permanent cache list is automatically determined. For example, the permanent cache list may be determined according to one or more steps such as one or more of those listed below and/or according to other steps. For example, according to some embodiments, if a file is a static dependency it will be added to the list. For example, according to some embodiments, if a file is a dynamically linked library loaded in the process space of the application it will be added to the list. For example, according to some embodiments, if a file is an “application file” or data file that is loaded at runtime it will be added to the list. For example, according to some embodiments, other files in the same directory of the loaded file that have the same extension will be added to the list. In some embodiments the algorithm can determine related files by analyzing files that have been loaded in the past to predict which files may be needed for future use. If there are more files than can fit in the cache, the algorithm will intelligently determine which files should be “pinned” to the cache by looking at fragmentation information, last access times and file size, for example.

A method for a user to select permanently cacheable files might be to drag and drop a folder or a list of files into a user interface. For example, a user might simply drag and drop an entire folder of files for a particular application to add them to the permanently cacheable list. However, in this case, the user would miss dependent files that are loaded from other directories (for example, from a Windows\System32 directory on the Microsoft Windows operating system). In such a case, the user would miss the benefits of the cache for those files not in the same directory as the application. Further, if a user drags an entire folder of files to create the dependent list, files may be included and added to the list that are not ever needed when running the application, thus reducing the useful cache size available for other applications. Therefore, in some embodiments, an automatic determination of the permanent cache list is desirable.

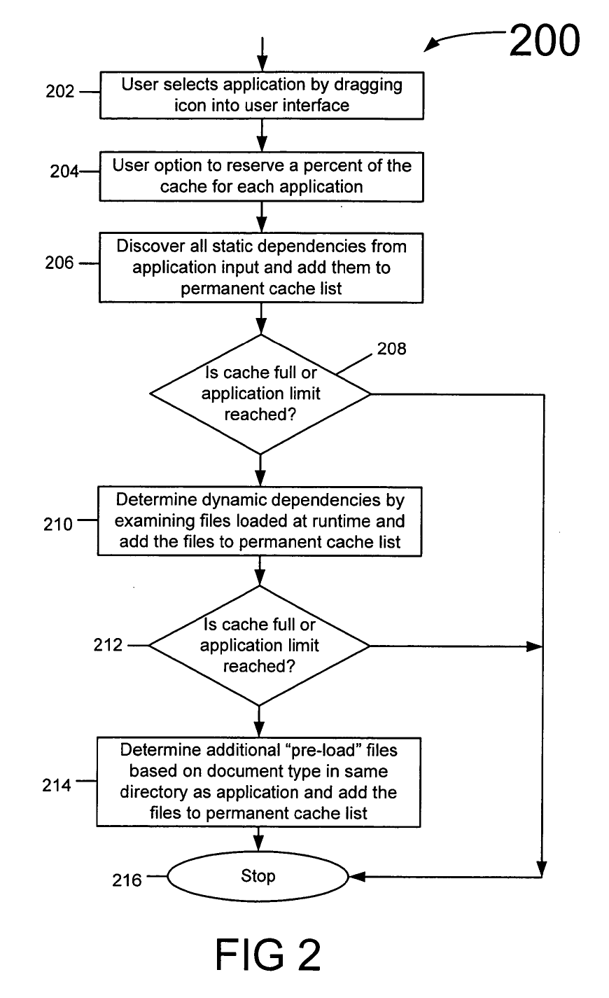

FIG. 2 illustrates a flow 200 according to some embodiments. In some embodiments flow 200 may be included as the disk cache logic illustrated in FIG. 1. In some embodiments flow 200 may be included within a disk cache and/or as separate logic from a disk cache. In some embodiments, flow 200 may be implemented as software, hardware, and/or firmware (including as some combination thereof). At 202 of flow 200 a user selects an application, for example, by dragging an icon into a user interface. At 204 a user can optionally reserve a percentage of cache space for each application. In some embodiments if no optional setting is made by a user at 204 then the entire cache will be used without reserving a percentage of cache space for each application. At 206, based on the application input by the user, all static dependencies are discovered and added to the permanent cache list. For example, in some embodiments the static dependencies include predictive determination of files to be cached even if they were not loaded during a profile session (for example, predictive caching based on file system location, similarity in name to other files that were profiled and used at runtime, file size, and/or other static data). At 208 a determination is made as to whether the cache is full or an application limit is reached. If it is determined at 208 that the cache is full or the application limit is reached then flow stops at 216. If it is not determined at 208 that the cache is full or the application limit is reached then at 210 dynamic dependencies are determined by examining files loaded at runtime, and these files are added to the permanent cache list. At 212 a determination is made as to whether the cache is full or an application limit is reached. If it is determined at 212 that the cache is full or the application limit is reached then flow stops at 216. If it is not determined at 212 that the cache is full or the application limit is reached then at 214 additional “pre-load” files are determined based on, for example, document type in the same directory as the application, and the files are added to the permanent cache list. In some embodiments, for example, 214 will do more than look merely at file names. For example, file access times, files names, file sizes, and/or fragmentation data may be reviewed to make a determination on a file. In some embodiments, a list of candidate files are ranked based on most likely to least likely to be used and inserted in that order, for example. In some embodiments, for example, a decision is made in the case that the cache would be filled, which files are more likely to have a positive impact on performance by looking at access times, fragmentation information and file sizes, for example. After 214 has been performed, flow stops at 216.

In some embodiments disk caching is advantageously performed by users who frequently use the same applications and want the highest performance possible when using only those applications. In some embodiments a high ease of use is possible because a user makes a single selection to place an application in a permanent cache list, and dependent files and application data that might be associated with that file are automatically determined. In some embodiments games (for example, personal computer games) benefit highly by automatically adding applications and associated files such as dependent files and application data to a permanent cache list. For example, large data files can be preloaded into the cache before the game is run, thus speeding up performance when accessing those files. For example, in some embodiments, improvements of 40% to 50% in load times have been accomplished when compared to not adding game data to the permanent cache list (that is, using unpinned game data).

Some embodiments have been described herein as relating to permanently cacheable files or cacheable files and/or permanent cache lists or cache lists, for example. It is noted that these terms are generally used with or without the term “permanent” to mean roughly the same concept. That is, permanent as used herein is permanent in the sense, for example, that disk addresses representing an application will be in the cache until the user decides to purge them from the cache with some other data, for example (as opposed to being evicted from the cache based on some preprogrammed policy such as a least recently used algorithm). Additionally, other terms such as “pinned data” vs. “unpinned data”, etc. are used herein to discuss data in cache lists, cache files, permanent cache lists, permanent cache files, etc.

In some embodiments the benefits of permanent cacheable file lists are combined with the ease of use of a one button, automatic dependency checker. Such embodiments improve upon those that add a full directory of files, since they prevent adding unnecessary files and can also determine dependent files that are not in the same directory as the application.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

1-39. (canceled)

40. An apparatus comprising:
a system that comprises hardware, the system being usable with flash memory and at least one hard disk drive, the system to determine certain data to be stored in the flash memory from the at least one hard disk drive based upon file selection both via a user interface and an automatic pinning algorithm;
the algorithm being based at least in part upon relative likelihood of use of the certain data.

41. The apparatus of claim 40, wherein:
the apparatus further comprises the disk drive and the flash memory.

42. The apparatus of claim 40, wherein:
the algorithm is to determine disk addresses of the certain data to be stored in the flash memory.

43. The apparatus of claim 40, wherein:
the algorithm comprises a least-recently-used eviction algorithm.

44. The apparatus of claim 40, wherein:
the system is implemented as a combination of firmware and the hardware.

45. The apparatus of claim 40, wherein:
the system comprises a computing platform that comprises a computer and one or more storage media to store instructions executable by the computer; and
the user interface is to permit selection of one or more file folders associated with an operating system of the computing platform.

46. An apparatus comprising:
a system comprising hardware, the system being usable with a flash memory, the system to store to a reserved space of the flash memory certain data that are to remain in the flash memory, regardless of an eviction algorithm associated with the flash memory, until a user selects the certain data to be removed from the flash memory, the reserved space to be selected by the user;
the system also to cache in the flash memory other data from a hard disk drive, the other data to be evicted from the flash memory based upon the eviction algorithm;
the eviction algorithm to evict based upon recency of use of the other data.

47. The apparatus of claim 46, wherein:
the apparatus further comprises the disk drive and the flash memory.

48. The apparatus of claim 46, wherein:
the eviction algorithm is executed automatically.

49. One or more computer-readable memories storing instructions that when executed by a machine result in performance of operations comprising:
storing in a reserved space of a flash memory certain data that are to remain in the flash memory, regardless of an eviction algorithm associated with the flash memory, until a user selects the certain data to be removed from the flash memory, the reserved space to be selected by the user;
caching in the flash memory other data from a hard disk drive, the other data to be evicted from the flash memory based upon the eviction algorithm;
the eviction algorithm to evict based upon recency of use of the other data.

50. The one or more computer-readable memories of claim 49, wherein:
the eviction algorithm is executed automatically.
